(19) United States
(12) Patent Application Publication
(10) Pub. No.: US 2015/0278212 A1
(43) Pub. Date: Oct. 1, 2015

(54) SYSTEM AND METHOD FOR DETERMINING AN OBJECT CONTEXT

(71) Applicant: Sven Krueppel-Berndt, Muehlhausen (DE)

(72) Inventor: Sven Krueppel-Berndt, Muehlhausen (DE)

(21) Appl. No.: 14/230,885

(22) Filed: Mar. 31, 2014

(51) Int. Cl. G06F 17/30

(52) U.S. Cl. CPC G06F 17/3053; G06F 17/30864

(57) ABSTRACT

A system and method for personal information management that retrieves one or more data fields of an object originating from one of a plurality of integrated or linked applications, stores the data fields for multiple objects, calculates one or more relevance values and context information for an active object based on the stored data fields, and graphically renders the context information.

### FIELD OF INVENTION

The present invention relates to personal information management applications, and more particularly, to personal information management applications that determine a context for active information objects.

### BACKGROUND

In today's hyper information age, it is not uncommon to manage numerous sources of information. Many existing applications have been developed to manage a single type of information object. For example, some individual applications have been developed to manage e-mail, calendars, tasks, notes, etc. Similarly, some larger applications (e.g., Microsoft Outlook) have been developed to manage multiple object types. Such larger applications typically include search functions so that a user may locate particular information objects, such as a meeting with Joe or an e-mail from Jane. However, both single and multiple object type applications have limited capability to track relationships between multiple objects.

Advances in computing technologies have enabled smaller devices, such as mobile phones and tablets, to execute more sophisticated functions and applications. As a result, people often utilize their mobile phones and tablets to perform many of the functions that they previously performed on their personal computers and laptops. For example, users now view websites, e-mail, and calendars on their mobile phones and tablets.

However, data aggregation mechanisms continue to be predominantly server based. Several server-based applications have been developed, using very large databases, to identify relationships between people. Examples of such applications include Google+, Facebook, LinkedIn, etc. Because of the size of the databases used, such applications are computationally intensive and must be implemented on at least one server. Moreover, such applications rely on a variety of information sources, and are not limited to personal information.

Accordingly, the inventor has identified a need to utilize information contained within a personal information management application to derive relationships between people and between information objects such as emails, meeting requests, etc.

### SUMMARY OF THE INVENTION

Accordingly, the present invention is directed to systems and methods for determining a context that substantially obviate one or more problems due to limitations and disadvantages of the related art.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the systems and methods for determining a context include module and/or steps for retrieving one or more data fields of an object originating from one of a plurality of integrated or linked applications, storing the data fields for multiple objects, calculating one or more relevance values and context information for an active object, and graphically rendering the context information.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this specification, illustrate embodiments of the disclosure and together with the description serve to explain the principles of the disclosure.

FIG. 1 is a block diagram showing components of a personal information management application according to an example embodiment.

FIGS. 2A-2E illustrate representative views of an example personal information management display according to an example embodiment.

FIG. 3 illustrates a representative view of an example relationship map according to an example embodiment.

FIG. 4 illustrates a method for using the personal information management application according to an example embodiment.

FIG. 5 illustrates a representative architecture of a portable electronic device according to an example embodiment.

### DETAILED DESCRIPTION

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments. Wherever possible, like reference numbers will be used for like elements.

Embodiments of user interfaces and associated methods for using a device are described. In some embodiments, the device is a portable communication device (e.g., a mobile phone or tablet). The user interface may include a touch screen and/or other input/output devices. In the discussion that follows, a portable communications device is used as an example embodiment. It should be understood, however, that the user interfaces and associated methods may be applied to other devices, such as personal computers and laptops, which may include one or more other physical user-interface devices, such as a keyboard and or mouse.

The portable communication device may support a variety of applications, such as telephone, text messenger, and personal information management applications. The various applications that may be executed on the device may use at least one common physical user-interface device, such as a touch screen. One or more functions of the touch screen as well as corresponding information displayed on the device may be adjusted and/or varied from one application to another and/or within a respective application. In this way, a common physical architecture of the device may support a variety of applications with user interfaces that are intuitive and transparent. In the discussion that follows, a personal information management application is used as an example embodiment, but it should be understood that the user interfaces and associated methods may be applied to other applications.

By applying a personal information management application according to embodiments of the present disclosure, users will be better equipped to analyze vast amounts of data, and make more informed decision in real-time. The personal information management application of the present disclosure avoids data privacy problems by relying on information already available to user. In addition, the algorithms used to derive relationships may be executed locally on a mobile device or web browser. As a result, relationships between people and information objects are less computationally intensive and may be determined more quickly.

The described systems and methods derive a work context for an information object (e.g., an e-mail, calendar entry, etc.). The object may generally be characterized by participants, time, location and topic. For example, the present application describes systems and methods to derive and/or suggest a context by using information available in the electronic mailbox and calendar of the user. Additionally, the corresponding context may be determined by utilizing several types of information that include, but are not limited to, any combination of related people, communications (e.g., e-mails, etc.), meetings, notes (e.g., notes related to previous meetings), topics, documents, document storages (e.g., file shares, sharepoint folders, Wiki pages, etc.), action items and their status, and the like.

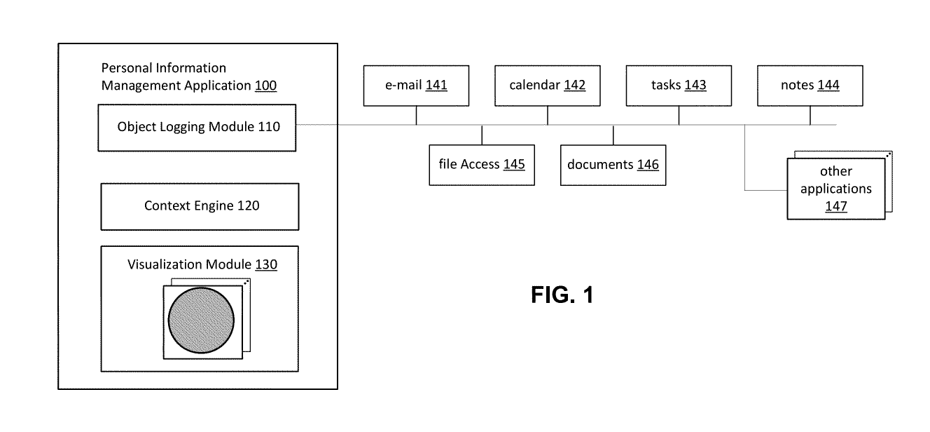

FIG. 1 is a block diagram showing components of a personal information management application according to an example embodiment.

As depicted in FIG. 1, personal information management application 100 includes object logging module 110, context engine 120, and visualization module 130. In addition, the object logging module 110 may be coupled to one or more other applications including e-mail application 141, calendar application 142, task application 143, notes application 144, file access application 145, document storage 146, and other applications 147. Although not shown, the object logging module 110 may also be coupled to one or more applications that manage multiple information object types (e.g., e-mails, meetings, etc.).

Object log module 110 stores a variety of data fields related to objects generated within any of applications 141-147. For example, data fields related each e-mail generated by e-mail application 141 may be stored within object logging module 110. In the e-mail example, sender (from), recipients (to: +cc:), subject line and/or conversation, the time/date (i.e., sent), and the storage folder (i.e., folder name) of an e-mail may be stored in the object log module 110. Here, individuals (i.e., senders and recipients) may be identified by a unique identifier such as an e-mail address. Accordingly, a distribution list may also be treated as an “individual” because the distribution list may be accessible by unique e-mail address. In some instances, a distinction between sender (from) and recipient (to, cc) may be desired. However, in some e-mail applications, such as conversation based e- systems, each of the senders within the conversation may be regarded as senders of the conversation.

In some instances, it may be desirable to filter and/or remove some e-mail objects from object logging module 110. Some example e-mails messages that may be filtered include messages with only bcc recipients, mass e-mails (e.g., greater than a predetermined number (say, 25, 35, . . . ) of recipients), e-mails without subjects, or non-substantive e-mails (e.g., out of office, declined/accepted meeting requests, etc.). In this example, various information fields associated with the e-mail message may be analyzed to determine whether an e-mail should be removed from object log module 110. When one or more information fields is missing, context engine 120 may be unable to determine relationship information from such e-mails or other objects.

In addition, it may be desirable to filter and/or remove information relating to the individual user of the personal information management application. As the individual user is typically contained in each of the logged e-mails and has some relationship to every other person in his mailbox, algorithms of context engine 120 may be unable to calculate meaningful results from the ubiquitous presence of the user.

Context engine 120 may utilize one or more algorithms to derive a context for an active object (or “situation” such as a past or proposed meeting, e-mail, task, etc.) based on information contained within object log module 110. Context may be represented by one or more calculated relevance values. As discussed above, each object may be characterized by one or more data fields including: persons (e.g., senders, recipients, and participants), time (e.g., e-mail sent time, meeting time, etc.), topic (e.g., e-mail subject or meeting title), related information objects (e.g., conversations), object type (e.g., e-mail, meeting, task, etc.).

The algorithms of context engine 120 compute one or more relevance values for each active information object. For example, there may be two levels of relevance determination: on situational level (e.g., e-mail, conversation, meeting, etc.) and on node level (e.g., person, topic, etc.). The relevance value(s) may be based on a multilevel relevance determination. Here, a relevance value R_{S,C} of an active object (or situation S) may be calculated by comparing the data fields of an active object to the data fields of objects stored within object logging module 110. For example, the comparison may be calculated along one or more dimensions, including conversation match (e.g., subject of evaluated e-mail matches to subject of meeting), people match (e.g., same sender or recipient), topic match (e.g., search term of topic is expressly contained in subject). In some instances, multiple dimensions may be used and an overall relevance value R_{S,C} may be calculated as a weighted sum of each dimension. Alternatively, of additionally, an aging function may be applied to give newer information objects within object logging module 110 greater relevance.

Other relevance values may also be calculated. For example, person relevance values R_{P,C} and the topic relevance values R_{T,C} may also calculated for each person/topic associated with the an active object. Person and topic relevance values may also be calculated by comparing data fields of the new object to the data fields of objects stored within object logging module 110. In addition, the filtering and weighting of various data within object logging module 110 may be applied during the calculation of any of the relevance values, including R_{S,C}, R_{P,C, and R}_{T,C}.

In some embodiments, the context engine 120 may identify or propose “derived” topics. For example, a derived topic may not be explicitly mentioned in an e-mail or meeting subject line, but may be derived based on the persons associated with the active object. In this example, a derived topic may be generated indirectly from contexts most relevant to the associated persons, as expressed by person relevance values R_{P,C}. The capability to quickly suggest related topics, even though they are not explicitly mentioned in one of the data fields (e.g., the subject line) of a data object is especially useful on a client-side portable computing device. In some instances, topics may be accounted for when at least two associated persons match the context.

Visualization module 130 of the personal information management application may generate and display one or more displays. Each component section of the main display may be generated based on data retrieved from the object logging module 110 and context engine 120. In other words, software code may be adapted to produce visualization of relationships and contexts as one or more chart displays.

Visualization module 130 may generate one or more pages of the personal information management application to be provided on a display of a host via an Internet browser or a standalone application. Visualization module 130 may employ SAP® UI5 (i.e., a user interface for HTML5) and other display techniques. More generally, the visualization module 130 may be based on any document language (e.g., markup language) or other-type language for structuring and presenting content to the user. The document language may include HyperText Markup Language (HTML) (e.g., HTML5), but is not so limited.

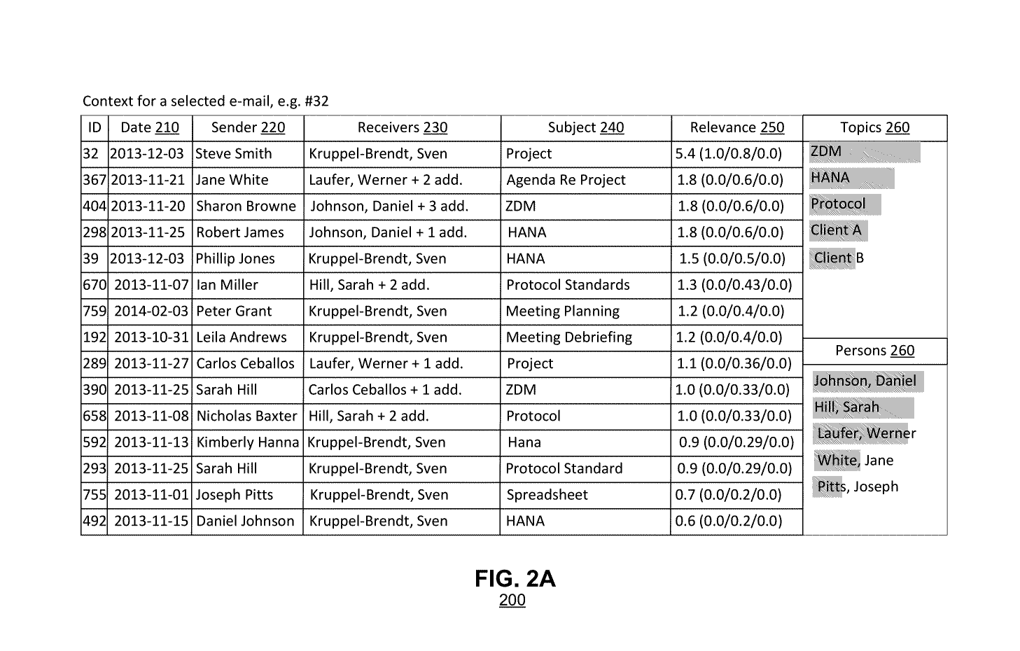

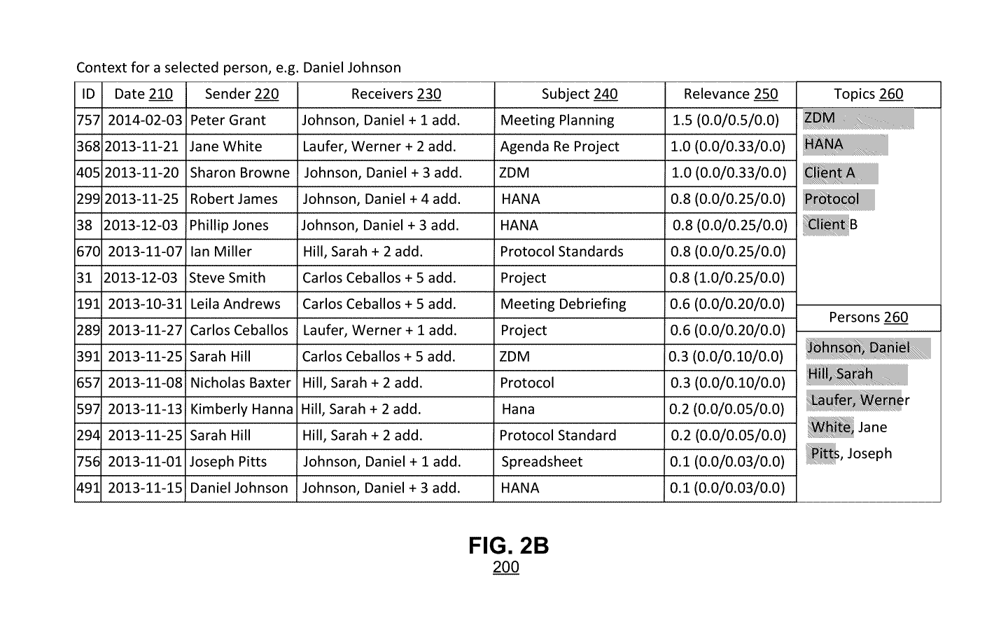

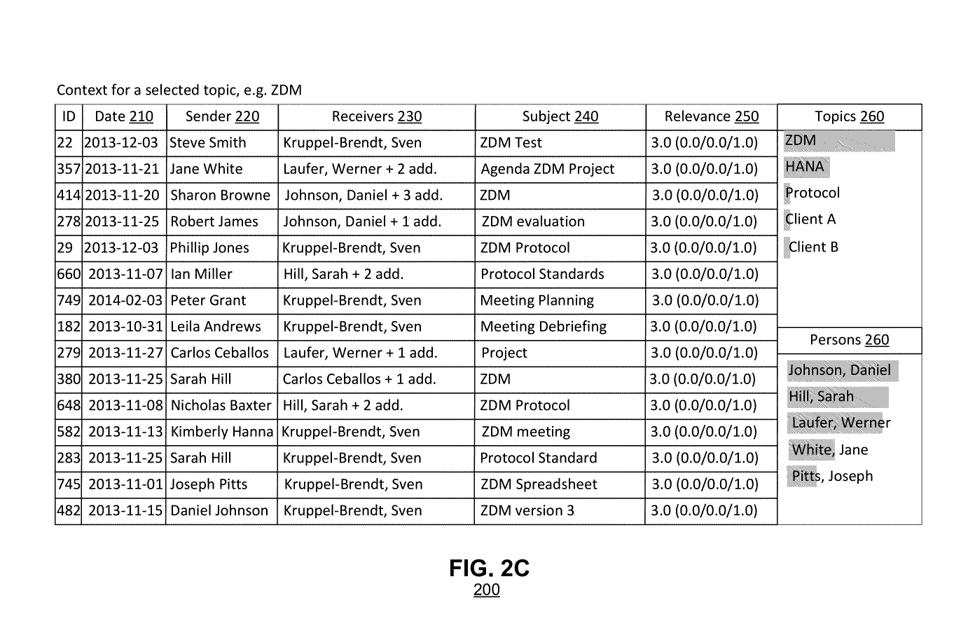

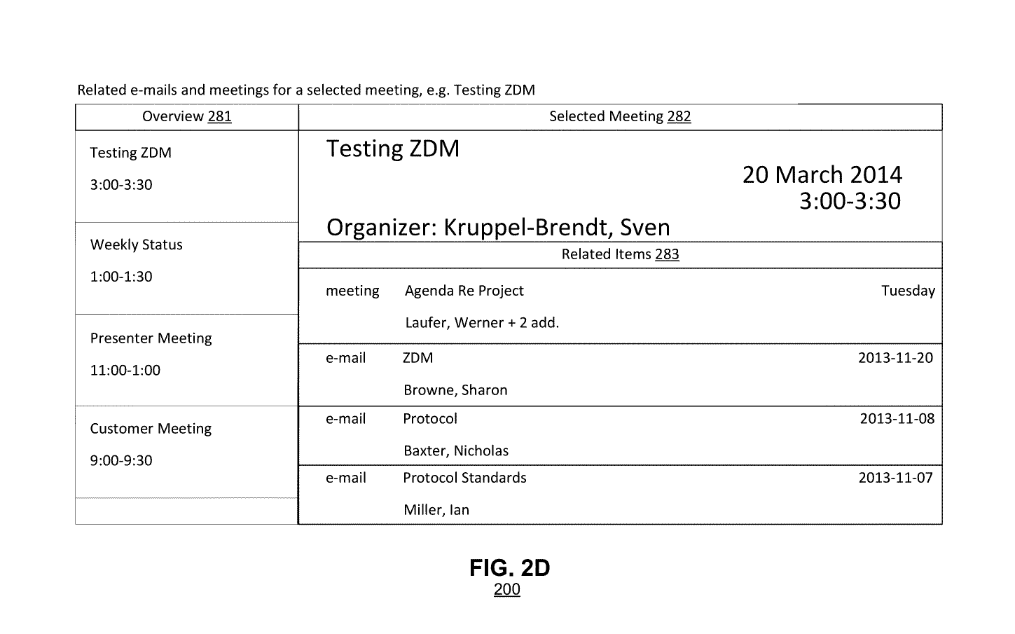

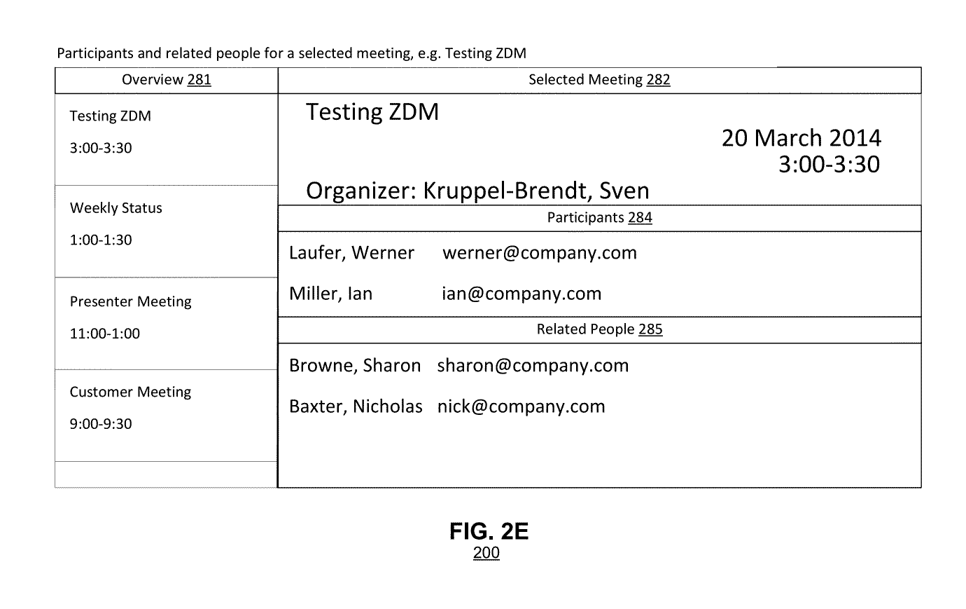

FIGS. 2A-2E illustrate representative views of an example personal information management display according to an example embodiment. As shown in each of FIGS. 2A-2C, the personal information management display 200 includes multiple component sections, such as date section 210, sender section 220, recipient section 230, and subject section 240. Sections 210-240 generally incorporate or implement features of a typical e-mail application. As alluded to above, however, the personal information management application and display further introduce additional modules and/or components to provide relevance values section 250, topics section 260, and relevant persons section 270.

FIG. 2A depicts an example context for a particular e-mail message, the context including related objects (e.g., e-mails, meetings, etc.), related topics as depicted in topics section 260, and related persons as depicted in relevant persons section 270. Similarly, example contexts may also be displayed for particular individuals and particular topics, as depicted by FIGS. 2B and 2C, respectively. In each of FIGS. 2A-2C, the computed relevance values may also be shown in relevance values section 250.

FIG. 2D depicts an example display illustrating related e-mail and meeting objects for a selected meeting. As shown in FIG. 2D, a plurality of meetings may be displayed in overview section 281, detailed information about a selected meeting object may be displayed in selected meeting section 282, and related objects, such as e-mails and/or past or upcoming meetings, may be displayed in related items section 283.

FIG. 2E depicts an example display illustrating participants and related people for a selected meeting. As shown in FIG. 2E, a plurality of meetings may be displayed in overview section 281, detailed information about a selected meeting object may be displayed in selected meeting section 282, and meeting participants may be displayed in participant section 284. In addition, people potentially relevant to the selected meeting may be displayed in related people section 285. Here, if a user generates a new e-mail message regarding the selected meeting, the personal information management application may automatically generate proposed recipients. For example, the user may be presented with a list of proposed recipients including meeting participants and related people. In this example, the user may select e-mail recipients in a variety of ways, such as a checkbox associated with each potential recipient. The personal information management application may then generate an e-mail message including the selected recipients.

In some embodiments, one or more bars may be used to depict the relative relevance of each of the listed topics and persons, as depicted in sections 260 and 270, respectively. Although a bar chart is shown, other graphical representations are also feasible. For example, captions (e.g., above, beneath, when highlighted or selected) may be used to indicate the relative relevance of a particular topic or person.

The personal information management application may be linked or integrated with one or more applications, including e-mail, calendar, task, notes, file access, document storage and other applications. In the illustrated example, the personal information management application incorporates or implements sections 210-240 to provide functions of an e-mail application. Each of the display sections may be fully integrated modules of the personal information management application, or may retrieve objects (e.g., e-mails, calendar entries, etc.) from one or more standalone applications.

The component sections of personal information management display 200 may be rearranged, resized, added and/or removed by a user to customize the display of the application. For example, a user may tap and hold on a desired component section and then drag the component section to move the selected screen to a new location on the display page. In another example, each component section may include a preferences menu. The preferences menu may be invoked by selecting a component section (e.g., right click or a double tap). The example preferences menu may include display configuration and format settings, additional information, options to delete the one or more portions of the display, and other options to modify or control the display.

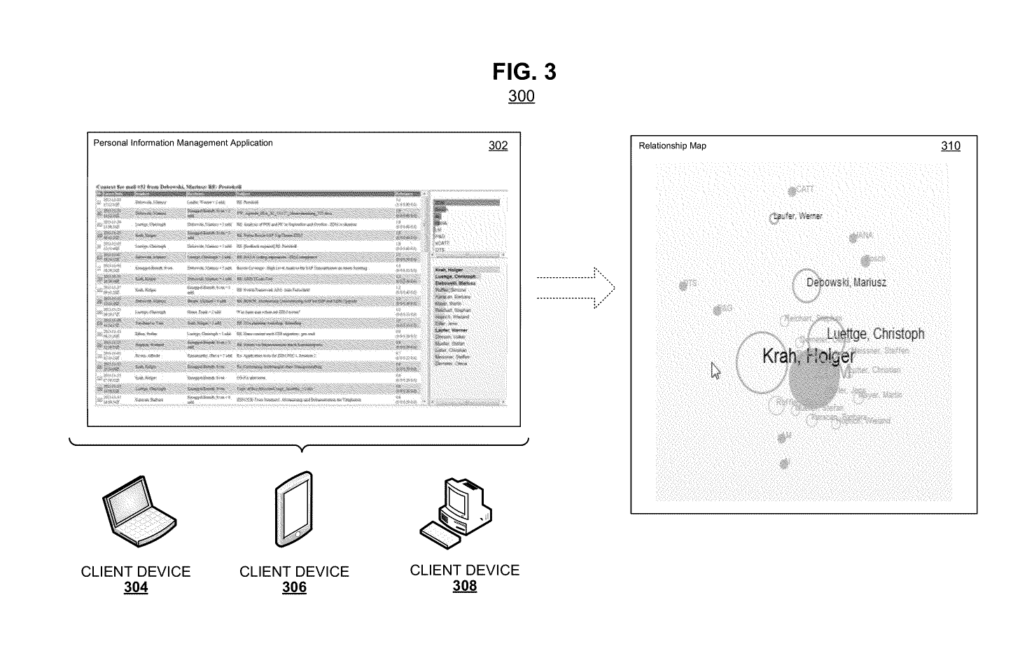

FIG. 3 illustrates a representative view of an example relationship map according to an example embodiment.

As shown in FIG. 3, the personal information management application 300 may include a main display 302, as described in connection with FIGS. 2A-2C. More detailed information for particular contexts and/or relationships between objects may also be illustrated in supplemental display 310. In the example depicted in FIG. 3, a relationship map between numerous people is shown. The personal information management application 300 may be displayed on a variety of client devices 304, 306, or 308 which may include, for example, a mobile device (e.g., mobile phone or a smartphone), a personal computer, a laptop, a tablet, or the like.

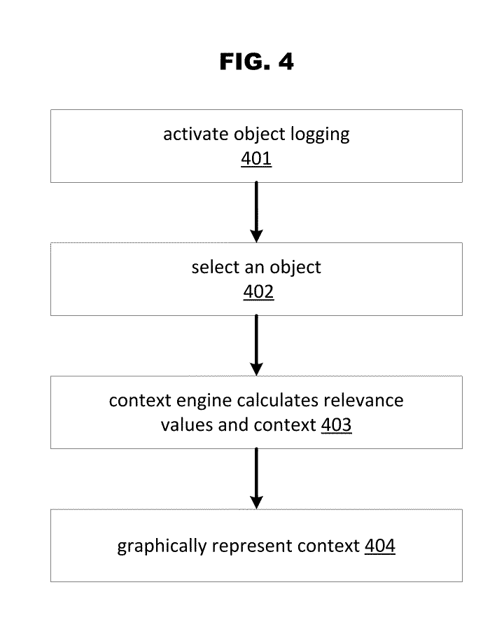

FIG. 4 illustrates a method for using the employee management application according to an example embodiment.

At step 401, a user activates the object logging module 110 of the personal information management application. Once activated, the object logging module 110 stores a variety of data fields related to objects generated within any of the linked or integrated applications. As the information stored within the object logging module 110 expands, the capabilities of the personal information management application expand as well.

Next, at step 402, a user selects an object. Here, a user may select any of the linked or integrated object types. For example, a user may select an e-mail message (FIG. 2A), calendar entry, task, or note. In addition, a user may also select an individual (FIG. 2B) or topic (FIG. 2C).

Once a user selects an object, the context engine 120 may automatically, or upon a user's command, calculate relevance values and context information for the selected object, at step 403. Here, context engine may calculate situation relevance value R_{S,C}, person relevance values R_{P,C} and the topic relevance values R_{T,C}. In addition, related objects, persons, and topics may also be identified.

Lastly, at step 404, one or more visualization modules of the personal information management module may generate a visual representation of an objects context, including related objects, topics, and persons. Here, the number related objects, persons, and topics may vary. In some embodiments, a bar or other chart type depicting the relative relevance of related objects, persons, and topics may be displayed adjacent to each respective entry. Visualizations of context information may be generated by a portable electronic device based on locally stored information.

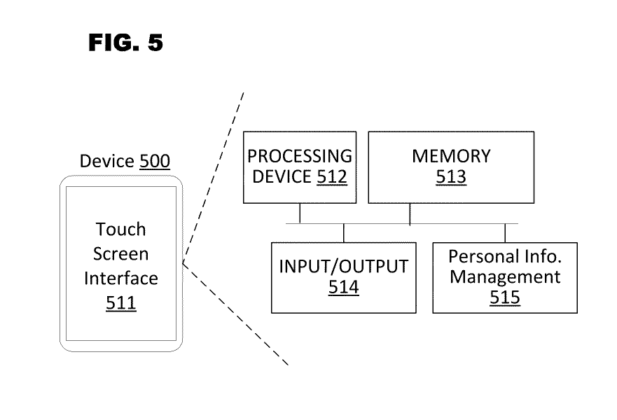

FIG. 5 illustrates a representative architecture of a portable electronic device according to an example embodiment.

A portable electronic device 500 may include a touch screen interface 511, processing device 512, memory 513, and input/output module 514. The touch screen interface 511 may include a display, which may be a touch screen, capable of displaying data to a user of the portable electronic device 500. Portable electronic device 500 may also include an information management application module 515 that generally implements the functionality of the personal information management application. The components and functions of the information management application module 515 are explained in detail with reference to FIGS. 1 and 2.

Although not shown, the touch screen may include a sensor that may be a capacitive touch detection sensor, configured to detect and track movement on the surface and/or in the vicinity of the display. The sensor may be coupled to a signal processing circuit that is configured to identify, locate, and/or track object movement based on the data obtained from sensor. The input/output module 514 manages the functionality of touch screen interfaced 511. For example, input/output module 514 may include functionality for identifying a component section within the personal information management application. An alternate component section may be selected by touching the alternate component section.

Memory 513 may include a computer readable medium storing application modules, which may include instructions associated with applications and modules of the portable electronic device 500.

The portable electronic device may contain a processing device 512, memory 513, and a communications device (not shown), all of which may be interconnected via a system bus. In various embodiments, the device 500 may have an architecture with modular hardware and/or software systems that include additional and/or different systems communicating through one or more networks via one or more communications devices.

Communications devices may enable connectivity between the processing devices 512 in the device 500 and other systems by encoding data to be sent from the processing device 512 to another system over a network and decoding data received from another system over the network for the processing device 512.

In an embodiment, memory 513 may contain different components for retrieving, presenting, changing, and saving data and may include computer readable media. Memory 513 may include a variety of memory devices, for example, Dynamic Random Access Memory (DRAM), Static RAM (SRAM), flash memory, cache memory, and other memory devices. Additionally, for example, memory 513 and processing device(s) 512 may be distributed across several different computers that collectively comprise a system. Memory 513 may be capable of storing user inputs and preferences as well as customized displays and templates. In some instances, a cache in memory 513 may store calculated changes to the profit per square foot based on modifications to product displays.

Processing device 512 may perform computation and control functions of a system and comprises a suitable central processing unit (CPU). Processing device 512 may include a single integrated circuit, such as a microprocessing device, or may include any suitable number of integrated circuit devices and/or circuit boards working in cooperation to accomplish the functions of a processing device. Processing device 512 may execute computer programs, such as object-oriented computer programs, within memory 513.

The foregoing description has been presented for purposes of illustration and description. It is not exhaustive and does not limit embodiments of the disclosure to the precise forms disclosed. For example, although the processing device 512 is shown as separate from the modules 514 and 515 and the touch screen interface 511, in some instances the processing device 512 and the touch screen interface 511 and/or one or more of the modules 514 and 515 may be functionally integrated to perform their respective functions.

It will be apparent to those skilled in the art that various modifications and variations can be made in the systems and methods for determining an object context of the present disclosure without departing from the spirit or scope of the disclosure. Thus, it is intended that the present disclosure cover the modifications and variations of this disclosure provided they come within the scope of the appended claims and their equivalents.

We claim:

1. A method comprising:
retrieving one or more data fields of an object originating from one of a plurality of integrated or linked applications;
storing the data fields for multiple objects;
calculating one or more relevance values and context information for an active object based on the stored data fields; and
graphically rendering the context information.

2. The method according to claim 1, wherein the relevance values include values for each of a context, topic, and person.

3. The method according to claim 1, wherein relevance information is graphically depicted for each of plurality of topics and each of a plurality of persons in bar form.

4. The method according to claim 2, wherein topics relevant to an object are displayed within the graphical rendering.

5. The method according to claim 2, wherein people relevant to an object are displayed within the graphical rendering.

6. The method according to claim 1, wherein the object may be an existing or proposed object.

7. The method according to claim 1, wherein the object is an e-mail message or calendar entry.

8. A non-transitory computer readable storage medium storing one or more programs configured to be executed by a processor, the one or more programs comprising instructions for:
retrieving one or more data fields of an object originating from one of a plurality of integrated or linked applications;
storing the data fields for multiple objects;
calculating one or more relevance values and context information for an active object based on the stored data fields; and
graphically rendering the context information.

9. The computer readable storage medium of claim 8, wherein the relevance values include values for each of a context, topic, and person.

10. The computer readable storage medium of claim 8, wherein relevance information is graphically depicted for each of plurality of topics and each of a plurality of persons in bar form.

11. The computer readable storage medium of claim 9, wherein topics relevant to an object are displayed within the graphical rendering.

12. The computer readable storage medium of claim 9, wherein people relevant to an object are displayed within the graphical rendering.

13. The computer readable storage medium of claim 8, wherein the object may be an existing or proposed object.

14. The computer readable storage medium of claim 8, wherein the object is an e-mail message or calendar entry.

15. A portable electronic device comprising:
one or more processors; and
memory storing one or more programs for execution by the one or more processors, the one or more programs including instructions for:
retrieving one or more data fields of an object originating from one of a plurality of integrated or linked applications;
storing the data fields for multiple objects;
calculating one or more relevance values and context information for an active object based on the stored data fields; and
graphically rendering the context information.

16. The portable electronic device according to claim 15, wherein the relevance values include values for each of a context, topic, and person.

17. The portable electronic device according to claim 15, wherein relevance information is graphically depicted for each of plurality of topics and each of a plurality of persons in bar form.

18. The portable electronic device according to claim 16, wherein topics relevant to an object are displayed within the graphical rendering.

19. The portable electronic device according to claim 16, wherein people relevant to an object are displayed within the graphical rendering.

20. The portable electronic device according to claim 15, wherein the object may be an existing or proposed object.

21. The portable electronic device according to claim 15, wherein the object is an e-mail message or calendar entry.

22. A portable electronic device comprising:
one or more processors; and
memory storing a plurality of integrated programs for execution by the one or more processors, one of the plurality of integrated programs including:
an object logging module for retrieving one or more data fields of an object originating from one of the plurality of integrated programs;
a context engine for calculating one or more relevance values and context information for an active object based on the data fields; and
a visualization module for graphically rendering the context information.
